(19) United States
(12) Patent Application Publication
(10) Pub. No.: US 2023/0329135 A1
(43) Pub. Date: Oct. 19, 2023

(54) Prevent motor of rototiller burnout

(71) Applicant: Ji-Hong Alex Wu, Kanata (CA)

(72) Inventor: Ji-Hong Alex Wu, Kanata (CA)

(21) Appl. No.: 17/723,379

(22) Filed: Apr. 18, 2022

(51) Int. Cl. A01B 33/10; A01B 33/02

(52) U.S. Cl. CPC A01B 33/10; A01B 33/021; A01B 33/028

(57) ABSTRACT

A unit is disclosed herein for removing long roots and grasses twined on a rototiller motor axle. Includes; an L-shaped unit; two holes for securing each unit to the rototiller blade using screws.

### TECHNICAL FIELD

The present invention generally relates to improvements in rototiller blades.

### BACKGROUND

Rototillers have a tendency to get long roots and grasses stuck in the axles of motors, causing motor burnout. The attachment shown is designed to prevent long roots and grasses from getting twined on motor axles and causing motor burnout.

### SUMMARY OF THE INVENTION

The object of the present invention is to provide rototillers with a way to automatically remove long roots and grasses from its blades, eliminating the need to manually remove the long roots and grasses. The present invention prevents motor burnout by long roots and grasses.

According to the present invention, as a rototiller blade rotates, the present invention will rotate along with it, as it rotates, the attachment will cut any grasses caught on the blade utilizing the sharp side on the attachment.

### BRIEF DESCRIPTION OF THE DRAWINGS

FIG. 1 shows an isometric view of a rototiller, with the attachment of the present invention.

FIG. 2 shows a side view of the blades on a rototiller, with the attachment of the present invention.

FIG. 3 shows a front view of the blades on a rototiller, with the attachment of the present invention.

FIG. 3A shows a front detailed view of the blades on a rototiller, with the attachment of the present invention in the area marked with dotted lines.

FIG. 3B shows a front detailed view of my claim, one unit of the 4 attachments.

FIG. 4 shows a side detailed view of the left side blades on a rototiller, with the attachments of the present invention in the area marked with the dotted lines.

FIG. 4A shows the back of FIG. 4.

FIG. 5 shows a side detailed view of the right-side blades on a rototiller, with the attachments of the present invention in the area marked with the dotted lines.

FIG. 5A shows the back of FIG. 5.

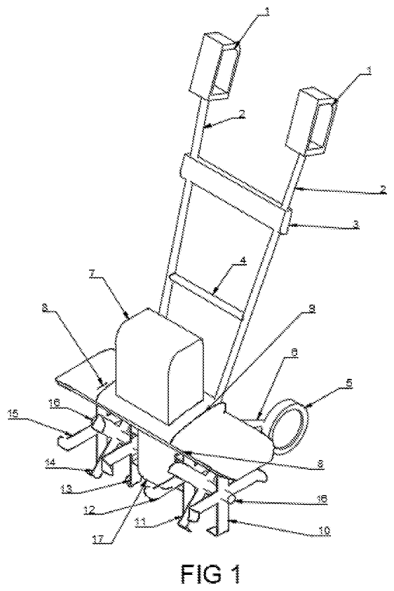

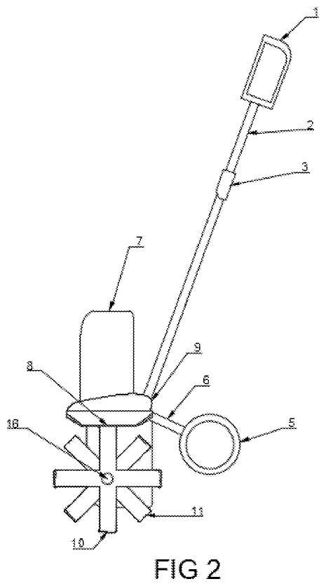

### DETAILED DESCRIPTION OF EMBODIMENTS

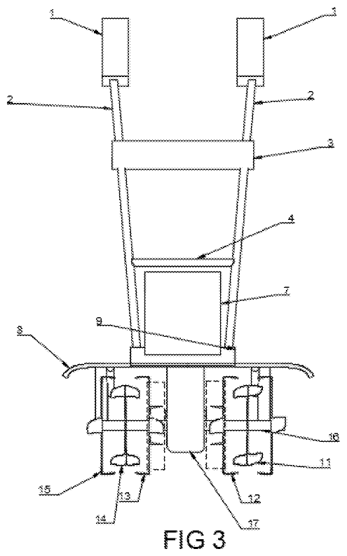

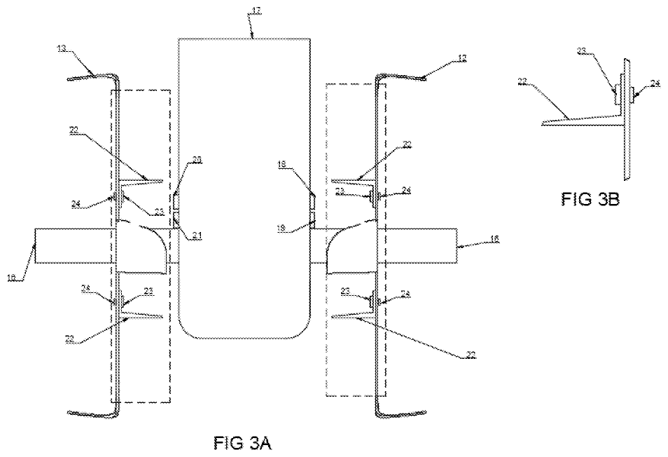

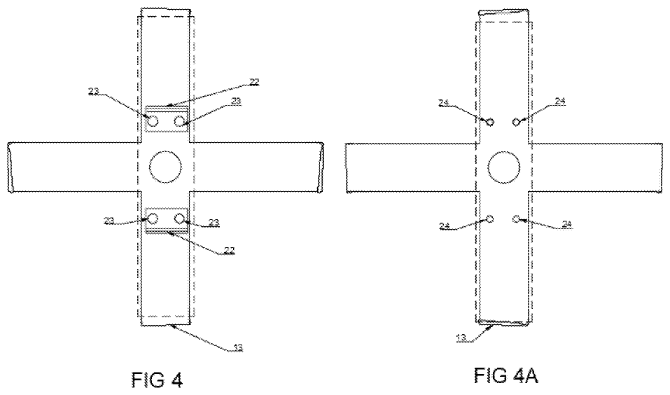

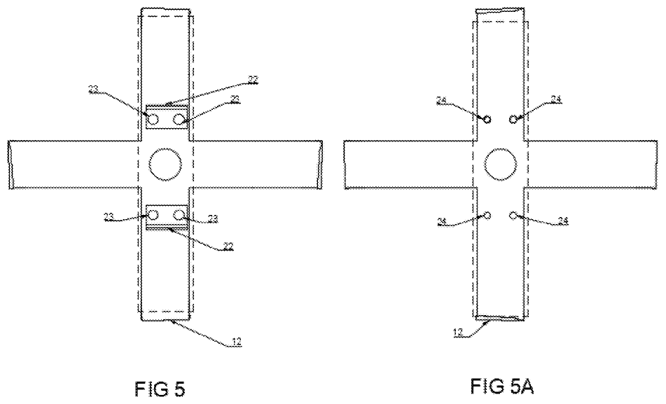

One unit, shown in FIG. 3B, consists of an L-shaped piece of metal 22, is fastened with two screws, each screw made of 23 and 24. On blade 13, two units are fastened onto the blade shown in FIG. 4 and FIG. 4A. On blade 12, two units are fastened onto the blade shown in FIG. 5 and FIG. 5A. Two units are fastened onto a rototiller blade using screws anywhere within the top of the rototiller blade to the bottom of the rototiller blade shown in the dotted line area used to remove long roots and grasses twined on a rototiller motor axle 16. Without my claim, long grasses and long roots would get stuck on the rototiller axle 16, the area between (12 and 17), and (13 and 17), it will cause motor burnout. Long grasses or roots will be cut by my claim with high speed at running time.

### Operation and Safety

To install the attachment, simply bolt it onto a rototiller blade using the screws provided. Before each use, check for any signs of warping, or bending. If warping is present on the plating, replace it.

If any loose screws or bolts are present, fasten them before operation.

What is claimed is:

1. Two units are fastened onto a rototiller blade using screws anywhere within the top of the rototiller blade to the bottom of the rototiller blade shown in the dotted line area used to remove long roots and grasses twined on a rototiller motor axle. One rototiller blade has 2 units.

2. My claim includes two rototiller blades on opposite sides of the motor with 4 units in total.
